(19) United States
(12) Patent Application Publication
(10) Pub. No.: US 2014/0278649 A1
(43) Pub. Date: Sep. 18, 2014

(54) MODELING A GAP BETWEEN WORKLOAD AND NUMBER OF EMPLOYEES TO BE SCHEDULED BY CREATING AND USING NEW WORKLOAD LEVELS

(71) Applicant: ORACLE INTERNATIONAL CORPORATION, Redwood Shores, CA (US)

(72) Inventors: Nabil Guerinik, Boulogne-Billancourt (FR); Malika Guerinik, Boulogne-Billancourt (FR); Guillaume Beuchard, Nantes (FR)

(73) Assignee: Oracle International Corporation, Redwood Shores, CA (US)

(21) Appl. No.: 13/804,529

(22) Filed: Mar. 14, 2013

(51) Int. Cl. G06Q 10/06

(52) U.S. Cl. CPC G06Q 10/063116
USPC 705/7.16

(57) ABSTRACT

A computer and method formulate, for inclusion in a constraint to be used in scheduling employees to perform an activity a within a time slot s, a sum of a sequence of variables that are defined based on new workload levels, created to model a gap between: a number of employees needed to perform activity a in time slot s, and the number of employees to be scheduled to perform activity a in time slot s. The computer and method further prepare, for inclusion in a function to be optimized during scheduling, a scalar product of the sequence of variables and a sequence of values. Each value in the sequence of values depends on a distance between: the number of employees needed to perform activity a in the time slot s and a new workload level indicated by the corresponding variable with which the value is multiplied.

### BACKGROUND

It is common in today's businesses to prepare a forecast of the amount of work (also called “workload”) that may be expected in specific seasons of a year, e.g. a retailer such as Amazon may have greater workload in winter, e.g. in December before Christmas than during the rest of the year. To meet seasonal changes in workload, an organization may temporarily increase or decrease the number of workers, depending on the forecast of seasonal workload. However, even within a given week in a year, workload in an organization can vary. Such weekly and seasonal variation in workload can be handled by use of software known in the art that performs automatic scheduling of employees, to appropriately cover a forecast of the workload.

U.S. Pat. No. 6,823,315 entitled “Dynamic Workforce Scheduler” granted to Bucci et al. is incorporated by reference herein in its entirety as background. U.S. Pat. No. 6,823,315 appears to describe a method of dynamically scheduling a workforce, which includes obtaining employee preferences, determining a workforce schedule, determining a schedule value, iteratively modifying the workforce schedule, determining a schedule value for the modified workforce schedule, and comparing schedule values to determine a best workforce schedule.

U.S. Pat. No. 7,987,105 entitled “Traffic Based Labor Allocation Method and System” granted to McNeill et al. is incorporated by reference herein in its entirety as background. U.S. Pat. No. 7,987,105 appears to describe a method with inputs: user-defined minimum and maximum coverage, and a method of distribution. U.S. Pat. No. 7,987,105 appears to indicate that such a method may perform two steps: (1) using one of two methods of distribution, calculate labor recommendations at ½ or 1 hour intervals during operating hours of each day within a targeted time period; and (2) regulating recommendations, by user-defined minimum coverage and maximum coverage.

U.S. Pat. No. 7,725,339 entitled “Contact Center Scheduling Using Integer Programming” granted to Aykin is incorporated by reference herein in its entirety as background. This patent appears to describe workload changes during the course of an operating day, and from one day to another during a week. U.S. Pat. No. 7,725,339 appears to describe a method for formulating a Mixed Integer Linear Programming (MILP) model, and a solution algorithm for developing optimal schedules. More specifically, U.S. Pat. No. 7,725,339 appears to describe obtaining a solution to satisfy constraints of a MILP model with a minimization (maximization) type objective function, such as total cost.

U.S. Pat. No. 6,278,978 entitled “Agent Scheduling System And Method Having Improved Post-Processing Step” granted to Andre et al. is incorporated by reference herein in its entirety as background. U.S. Pat. No. 6,278,978 appears to state that evaluation of a score function for a possible schedule includes selecting, for each interval in the possible schedule, one of multiple predetermined values corresponding to distinct staffing levels. The predetermined values may correspond to whether the interval is very understaffed, slightly understaffed, slightly overstaffed, or very overstaffed. U.S. Pat. No. 6,278,978 appears to state that an overstaffing limit for an interval is a maximum number of agents that should be scheduled for an interval in excess of the agent requirement for the interval, and that an understaffing limit for any interval is a maximum number of agents that should be scheduled for the interval short of the agent requirement for the interval.

In the bottom of column 5, U.S. Pat. No. 6,278,978 states as follows. If Agents Scheduled in Interval<Agent Requirement-Understaffing Limit then Score=10. If Agent Requirement-Understaffing Limit<=Agents Scheduled in Interval and Agents Scheduled in Interval<Agent Requirement then Score=1. If Agent Requirement=Agents Scheduled in Interval then Score=0. If Agent Requirement<Agents Scheduled in Interval<=Agent Requirement+Overstaffing Limit then Score=−1. If Agent Requirement+Overstaffing Limit<Agents Scheduled in Interval then Score=−10.

U.S. Pat. No. 6,278,978 appears to use a post-processing procedure for optimizing a schedule. However, use of a post-processing procedure can have drawbacks, e.g. a large number of iterations may be needed to obtain a locally optimal schedule. When a maximum number of iterations is reached, the post-processing must be terminated, etc. Hence, there is a need for an improvement of the type described below.

### SUMMARY

In several aspects of described embodiments, a computer and method automatically model a gap between a number of employees needed to perform an activity a in a time slot s in a day (also called “standard workload”), and a number of employees to be scheduled in the time slot s to perform the activity a (also called “contribution”), by creating and using one or more new levels of workload. The one or more new workload level(s) may be created automatically, by performing any procedure which can depend on the embodiment. The new workload levels are automatically used to define one or more new variables, indicative of at least the new workload levels. The new variable(s) are automatically used to (1) formulate for use in a constraint, one or more sum(s), and (2) prepare for use in a function, one or more scalar product(s) of sequence(s) of the new variables and sequence(s) of values.

In some illustrative embodiments, the computer and method automatically formulate a representation of a sum in a constraint, by including therein a sequence of new variables (e.g. to model a gap between the standard workload and the contribution). Moreover, in such embodiments, the computer and method automatically prepare, as a representation of an expression in a function to be optimized during scheduling, a scalar product of a sequence of new variables and a sequence of values. The values may be predetermined to change monotonically in sequence, in the same direction (e.g. increase successively) as the change in distance of corresponding new workload levels from the standard workload (e.g. also increasing successively). Such representations of sums and expressions maybe stored on one or more non-transitory computer readable storage media in a model (e.g. linear) that is to be solved using a solver (e.g. linear), to develop schedules of employees.

Creation of one or more new workload levels as described above provides greater resolution in modeling a gap in coverage, relative to the prior art. Use of the new workload levels enables greater precision in assigning costs to schedules, relative to the prior art. In illustrative embodiments, as use of new variables in sequence denotes a successively larger gap between standard workload and contribution, the values in sequence used in the scalar product also increase successively. Hence, each increase in the gap (as indicated by successive variables in sequence becoming non-zero) is multiplied by successively larger increases in value, resulting in assignment of steeply increasing costs to employee schedules as their contribution becomes farther away from the standard workload. A schedule generated by use of new workload levels in representations as described above provides workload coverage that is more balanced across time intervals in a day, relative to coverage of schedules that do not use new workload levels.

It is to be understood that several other aspects and embodiments will become readily apparent to those skilled in the art from the description herein, wherein it is shown and described various aspects by way of illustration. The drawings and detailed description below are to be regarded as illustrative in nature and not as restrictive.

### BRIEF DESCRIPTION OF THE DRAWINGS

FIG. 1A illustrates, in a graph, new workload levels that are created by some embodiments of computer 1000, and variables based on the new workload levels that are used to model a gap in coverage.

FIGS. 1B and 1C illustrate, in graphs, sequences of values that correspond to sequences of the variables illustrated in FIG. 1A.

FIGS. 2A and 2B illustrate, in graphs, workload as a function of time in some exemplary schedules, and use of the variables of FIG. 1A and the values of FIGS. 1B and 1C to compute cost of each schedule.

FIG. 3 illustrates, in a high-level flow chart, acts performed by a computer 1000 in several embodiments, to formulate constraints and prepare expressions and store them in model 400 of FIG. 4.

FIG. 4 illustrates in a high-level data flow diagram, model 400 generated by a model generator 440 for use by a solver 420 in some embodiments of the invention.

FIGS. 5A and 5B illustrate, in block diagrams, hardware and software portions of a computer 1000 that performs the method illustrated in FIG. 3.

### DETAILED DESCRIPTION

In several aspects of described embodiments, a computer 1000 (FIG. 5A) and a method performed by the computer 1000 use a model 400 (FIG. 4) to create schedules of one or more activities to be performed by employees in an organization, based on a forecast for a specific interval of time (also called time slot s) of a number of employees needed to perform an activity a (also called standard workload, StD(a,s) which is illustrated in FIG. 1A by curve 101). In several embodiments, each schedule to be created may be a weekly schedule, which identifies the activities a to be performed by each employee e, in each time slot (e.g. of 15 minute duration) in a week. Thus, each time slot s is represented by at least a start time st and a day d of the week (e.g. Mon, Tue, Wed, Thu, Fri, Sat, Sun). Such a schedule may include break times during the day d and conform to user specified requirements (e.g. activity a identified as “cleaning” specified to be performed between 3 pm and 5 pm).

Certain illustrative embodiments automatically create one or more new workload level(s) for use in scheduling (also called timetabling) of employees based on the user specified requirements. Specifically, m−1 new workload levels may be automatically created by computer 1000 to be above (i.e. greater than) standard workload StD(a,s) and may be denoted e.g. as AboveStD(a,s,j) with j being an index that identifies each new workload level of overstaffing in time slot s of employees with skill in activity a and the index j has a value ranging from 1 to m−1. FIG. 1A illustrates located above curve 101 of standard workload StD(a,s), a newly-added overstaffing curve 105 which is an example of an AboveStD curve. A workload level farthest above the standard workload StD(a,s) is the maximum number of employees authorized by management of the organization, also called maximum staffing level MaxStaffing(a,s), which is illustrated in FIG. 1A by another newly-added curve 106. The newly-added curves AboveStD(a,s,j) are ordered by computer 1000 relative to one another as follows:

AboveStD(a,s,j+1)≧AboveStD(a,s,j).

Similarly, n−1 new workload levels may be automatically created by computer 1000 to be below (i.e. lower than) standard workload StD(a,s) e.g. denoted as BelowStD(a,s,i) with i being another index that identifies each new workload level of understaffing in time slot s of employees with skill in activity a and the index i has a value ranging from 1 to n−1. FIG. 1A illustrates two newly-added understaffing curves 102 and 103 located below curve 101 of standard workload StD(a,s), both being examples of BelowStD curves. Another newly-added workload level located farthest below standard workload StD(a,s) is the minimum number of employees required to operate the organization, also called minimum staffing level MinStaffing(a,s), which is illustrated in FIG. 1A by curve 104. The newly-added curves BelowStD(a,s,i) are ordered by computer 1000 relative to one another as follows:

BelowStD(a,s,i+1)≦BelowStD(a,s,i).

A specific manner in which new workload level(s) of the type illustrated in FIG. 1A are created by computer 1000 can be different, depending on the embodiment. In certain illustrative embodiments, the new workload levels are created to be a fraction of and/or a multiple of standard workload StD in each time slot s. The fraction and/or multiple which is used to add such new workload levels (and therefore new curves) may be predetermined, or may be determined automatically (and dynamically), or determined by computer 1000 based on user input (e.g. which may be specified for a time slot s or for a group of time slots), depending on the embodiment. The formula used by computer 1000 to compute the workload levels must satisfy the condition that the new workload levels never overlap. A way of calculation of curve index j may be based on the formula of the barycenter having the weight j between the standard demand StD(a,s), and the level MaxStaffing(a,s), (or MinStaffing(a,s)). In other embodiments, one or more new workload level(s) may be automatically created by repeatedly adding to or subtracting from standard workload StD, a fixed increment or a fixed decrement which may be identified, in any manner depending on the embodiment, for example, via user input or predetermined. Alternatively, such an increment or decrement to standard workload StD may be dynamically calculated when needed, e.g. based on a range of variation in or based on a standard deviation of standard workload StD.

Some embodiments of computer 1000 receive user input on maximum staffing level MaxStaffing(a,s) which an organization's management selects as not to be exceeded, in the scheduling of employees (e.g. in preparing a time table, or a schedule of activities to be performed by each employee). Such embodiments of computer 1000 may additionally or alternatively receive user input on minimum staffing level denoted as MinStaffing(a,s) which the management identifies as the number of employees to be assigned at a minimum, when scheduling employees. In such embodiments, the computer 1000 and a method implemented therein may be programmed to automatically create one or more new levels of workload denoted as BelowStD(a,s,i) between the standard workload StD(a,s) and the minimum staffing level MinStaffing(a,s) and further create one or more new workload levels denoted as AboveStD(a,s,i) between the standard workload StD and the maximum staffing level MaxStaffing(a,s). New levels of workload BelowStD(a,s,i) may be spaced by computer 1000 equally between StD(a,s) and MinStaffing(a,s) or alternatively spaced in a staggered manner at increasing distances from StD(a,s) (and correspondingly at decreasing distances from MinStaffing(a,s)), depending on the embodiment. Similarly, the new levels of workload AboveStD(a,s,i) may be spaced by computer 1000 equally between StD(a,s) to MaxStaffing(a,s) or alternatively spaced staggered from StD(a,s) to MaxStaffing(a,s), again depending on the embodiment.

Regardless of how new levels of workload BelowStD(a,s,i) and AboveStD(a,s,i) are created, these new workload levels are used in several embodiments of computer 1000 and a method it implements, to automatically define representations of one or more new variables, e.g. the variable name OverStaffing may be used to represent a surplus (or excess) in the number of employees, and the variable name UnderStaffing may be used to represent a deficit (or shortage) in the number of employees. Each variable may have three indexes to respectively represent: an activity a, a time slot s and an index that identifies a specific curve associated therewith e.g. OverStaffing(a,s,0) and UnderStaffing(a,s,0) are associated with the standard workload StD(a,s). The m−1 variables represented as OverStaffing(a,s,i), for i=1 to m−1, are associated respectively with the new workload levels AboveStD(a,s,i). The last variable represented as OverStaffing(a,s,m) is associated with the MaxStaffing curve. Similarly, the n−1 variables represented as UnderStaffing(a,s,i), for i=1 to n−1, are associated respectively with the new workload levels BelowStD(a,s,i). The last variable represented as UnderStaffing(a,s,n) is associated with the MinStaffing curve.

In the illustrative example of FIG. 1A, representations of the three new variables OverStaffing are automatically created by computer 1000 to identify the distances 1010, 1050 and 1060 which are measured relative to corresponding AboveStD curves 101, 105 and the MaxStaffing curve 106 located above the standard workload StD that these variables are indicative of. Additionally, in FIG. 1A, representations of the four new variables UnderStaffing are automatically created by computer 1000 to identify the distances 101U, 102U, 103U and 104U measured relative to corresponding BelowStD curves 101, 102, 103 and the MinStaffing curve 104 located below the standard workload StD that these variables are indicative of. Hence, in the illustrative example of FIG. 1A, representations of the seven new variables OverStaffing and UnderStaffing are automatically created by computer 1000 (based on six curves 101-106), and may thereafter be used to model a gap in coverage between a number of employees needed to perform an activity a in a time slot s, and a number of employees to be scheduled in time slot s, to perform the activity a.

New variables OverStaffing and UnderStaffing may be used by a computer 1000 and a method of some embodiments to (1) formulate representations (e.g. expressed as strings of text) of sums of the new variables, for use in a constraint, and (2) prepare representations (e.g. expressed as strings of text) of scalar products of a sequence of the new variables and a sequence of values, for use in a function to be optimized during scheduling (also called “cost” function).

Specifically, some embodiments of a computer and method create the following representation (e.g. expressed as a string of text) of a sum for use in a constraint:

$${\sum }_{i = 0}^{n} UnderStaffing ( a , s , i ) . \qquad Expression ( 1 ) .$$

Hence, in certain embodiments that use Expression (1) above to formulate a representation of a sum, each variable in a sequence of variables may be used to denote a portion of understaffing represented by a gap, when the number of employees needed to perform the activity a in the time slot s is greater than the number of employees to be scheduled in the time slot s and skilled at performing the activity a. The computer and method may (depending on the embodiment), further formulate a representation (e.g. expressed as another string of text) of the following sum, also for use in the constraint:

$${\sum }_{j = 0}^{m} OverStaffing ( a , s , j ) . \qquad Expression ( 2 ) .$$

Hence, in several embodiments that use Expression (2) above to additionally formulate the additional representation of another sum, each variable in another sequence of variables may be used to denote a portion of overstaffing represented by the gap, when the number of employees needed to perform the activity a in the time slot s is less than the number of employees to be scheduled in the time slot s and skilled at performing the activity a. Several embodiments combine these two representations of sums in the constraint by representing a difference therebetween as follows:

$${\sum }_{i = 0}^{n} UndersStaffing ( a , s , i ) - {\sum }_{j = 0}^{m} OverStaffing ( a , s , j ) \qquad Expression ( 3 ) .$$

Thus, some embodiments use as a constraint, a representation of subtraction between the understaffing sum and the overstaffing sum.

Moreover, the computer and method of some embodiments may prepare a representation of a scalar product of a sequence of the new variables UnderStaffing and a sequence of values UPenalty as follows, for use in a model of a scheduling problem, as a cost function:

$${\sum }_{i = 0}^{n} UPenalty ( i ) \times UnderStaffing ( a , s , i ) . \qquad Expression ( 4 ) .$$

The sequence of values UPenalty may be automatically selected to change monotonically, in the same direction (e.g. increase) as the distance of corresponding new workload levels UnderStaffing from the standard workload StD(a,s). The computer and method may (depending on the embodiment), further create the following representation of a scalar product, also for use in the cost function:

$${\sum }_{j = 0}^{m} OPenalty ( j ) \times OverStaffing ( a , s , j ) . \qquad Expression ( 5 ) .$$

In the above scalar product as well, the sequence of values OPenalty may be selected to change monotonically, in the same direction (e.g. increase) as the distance of corresponding new workload levels OverStaffing from standard workload StD(a,s). Several embodiments of the method and computer combine representations of these two scalar products (in Expression(4) and Expression(5) above) in a cost function to be used in solving the scheduling problem, by concatenating them with a “+” sign, thereby taking a sum thereof as follows:

$${\sum }_{i = 0}^{n} UPenalty ( i ) \times UnderStaffing ( a , s , i ) + {\sum }_{j = 0}^{m} OPenalty ( j ) \times OverStaffing ( a , s , j ) . \qquad Expression ( 6 ) .$$

The just-described sums and/or expressions are stored on one or more non-transitory computer readable storage media such as memory 1106 (FIG. 5A) in a model (e.g. linear) that is to be solved using a solver (e.g. linear), to develop daily schedules of employees to perform work in an organization. Creation of one or more new workload levels BelowStD below StD and/or creation of one or more new workload levels AboveStD above StD provides greater resolution in defining a gap in coverage, relative to the prior art. Use of such new workload levels by a computer and method of the type described herein increases precision in assigning costs to schedules, relative to prior art, e.g. as illustrated in FIGS. 2A and 2B and described below.

In some embodiments, as successive variables UnderStaffing(a,s,i) in the sequence i=0 to n are used by a computer and method in some embodiments to denote successively larger differences between standard workload StD and Contribution, the corresponding values UPenalty(i) in the sequence i=0 to n are predetermined in the computer and method to increase successively, as illustrated in FIG. 1C. For example, as shown in FIG. 1C, when a second value UPenalty(1) occurs in the sequence after the first value UPenalty(0), the second value UPenalty(1) is greater than the first value UPenalty(0). When a gap in coverage of the standard workload StD is described by variable UnderStaffing(a,s,0) in a representation of a sum, the gap is assigned a cost in a representation of a scalar product obtained by multiplying the variable UnderStaffing(a,s,0) with the value of UPenalty(0). Specifically, a larger gap denoted in a summation representation by the sum of two variables UnderStaffing(a,s,0) and UnderStaffing(a,s,1), has a cost in a scalar product representation obtained by multiplying these two variables with corresponding two values UPenalty(0) and UPenalty(1).

In the example illustrated in FIG. 1C, the values are predetermined by a computer and method of the type described herein in sequence relative to one another so that UPenalty(1)≧UPenalty(0), so that an increase in cost is not proportional to the increase in gap (i.e. not linear). More generally, every new workload level BelowStD(a,s,i) located below StD is associated by a computer and method in certain embodiments with not only a variable UnderStaffing(a,s,i) but also a value UPenalty(i) such that UPenalty(i+1)≧UPenalty(i). Similarly, as shown in FIG. 1B, every new workload level AboveStD(a,s,j) located above StD is associated by a computer and method in several embodiments with not only a variable OverStaffing(a,s,j) but also a value OPenalty(j) such that OPenalty(j+1)≧OPenalty(j).

Hence, as shown in FIGS. 1B and 1C, increasing changes in the gap in the coverage of a standard workload (as indicated by successive UnderStaffing variables or OverStaffing being needed to be used) are penalized by a computer and method in some embodiments by use of increasing values UPenalty or OPenalty corresponding thereto. Use of successively increasing penalties as shown in FIGS. 1B and 1C results in assignment of steeply increasing costs (obtained as the sum of products in Expressions (4) and (5) described above), to employee schedules in which Contribution becomes farther and farther away from StD. Therefore, a schedule generated by a computer and method of some embodiments by use of the new workload levels BelowStD(a,s,i) with i ranging from 0 to n and/or AboveStD(a,s,j) with j ranging from 0 to m as described above provides coverage of workload that is more balanced across time intervals (e.g. of 15 minutes each) in a day, relative to coverage by schedules generated in the prior art.

Specifically, FIG. 2A illustrates an activity, such as “cashier” in a retail store, that needs 7 employees between 8 am and 10 am (which is denoted by a standard workload StD curve 101), and during this time period the number of employees to be scheduled to work as cashier (i.e. Contribution) is also 7 so the cost for this period is zero (i.e. 0). In the example of FIG. 2A, between the period 10 am and 11:45 am, there are 8 employees assigned to this activity (e.g. “cashier”) as shown by the Contribution curve 121, and during this time the standard workload StD curve 101 remains at 7 employees. Therefore, between the period 10 am and 11:45 am, the new variable OverStaffing (a,s,0) for j=0 (shown in FIG. 2A by reference numeral 105A) has the value 1. In this example, a cost for the period between 10 am and 11:45 am is obtained by multiplying the variable OverStaffing(a,s,0) of value 1 with a value OPenalty(0) for j=0 to be used as a penalty for over staffing e.g. the value 0.5. The result of multiplication 0.5 is then itself repeatedly summed up, across a number of 15 minute intervals for different values of s during which variable OverStaffing(a,s,0) has the same value (e.g. 7 intervals). So, the result of summation is the value 3.5 which represents the cost of over staffing during the period between 10 am and 11:45 am in the schedule illustrated in FIG. 2A.

During the period between 11:45 am and 12:45 pm in FIG. 2A, Contribution curve 121 remains unchanged at 8 employees while standard workload StD curve 101 is at 9 employees. Hence, in the period between 11:45 am and 12:45 pm, the new variable UnderStaffing(a,s,0) for i=0 (shown in FIG. 2A as the quantity 105B) is 1 thus the cost of under staffing is 4 (assuming the value UPenalty(0) for i=0 is 1 for under staffing). In this example, the value UPenalty(0) used for a first increment of under staffing below standard workload StD(a,s) may be selected based on user input to be twice the value OPenalty(0) used for the first increment of over staffing above standard workload StD(a,s). The just-described user input specifying a multiplier relationship between the two first values UPenalty(0) and OPenalty(0) may be based on business judgment of relative difference in profits and loss, based on under staffing's loss of revenue relative to over staffing's loss of wages.

In the period between 12:45 am and 1:00 pm illustrated in FIG. 2A, the Contribution curve 121 increases to 9 employees while standard workload StD curve 101 drops to 5 employees. Hence, in the period between 12:45 am and 1:00 pm, the total amount of over staffing is 4 (shown in FIG. 2A as the quantity 105C). Note that if the cost were to be computed in the normal manner, the cost would be 4*0.5=2. In this example, however, one AboveStD curve 105 is located above standard workload StD curve 101 and below Contribution curve 121. Hence, in this example, there are two OverStaffing variables that are automatically named by a computer and method of some embodiments as OverStaffing(a,s,0) by setting j=0 (shown in FIG. 2A by reference numeral 105C2), and OverStaffing(a,s,1) by setting j=1 (shown in FIG. 2A by reference numeral 105C1), which are respectively 2.5 and 1.5. In this example, if the value OPenalty(0) for j=0 is 0.5 and if the value OPenalty(1) for j=1 is 1.0 corresponding to variables OverStaffing(a,s,0) and OverStaffing(a,s,1) respectively, then the cost in the period between 12:45 am and 1:00 pm may be calculated as 2.5*0.5+1.5*1=2.75.

Finally, in the period between 1:00 pm and 1:15 pm illustrated in FIG. 2A, the Contribution curve 121 drops to 7 employees while standard workload StD curve 101 remains unchanged at 5 employees. Hence, in the period between 1:00 pm and 1:15 pm, the variable OverStaffing is 2 (shown in FIG. 2A as the quantity 105D), thus the cost is 1 (assuming penalty is 0.5 for over staffing). Thereafter, in the period between 1:15 pm to 5:00 pm, the Contribution curve 121 matches the standard workload StD curve 101 so the cost is 0. Hence, total cost for the schedule of FIG. 2A is 3.5+4+2.75+1=11.25.

In an alternative schedule illustrated in FIG. 2B, the cost computation may be done as described above for FIG. 2A up until 12:45 pm. During the period between 12:45 pm and 1:15 pm illustrated in FIG. 2B, the Contribution curve 121 remains unchanged at 8 employees while standard workload StD curve 101 drops to 5 employees. Hence, in the period between 12:45 pm and 1:15 pm, there are two OverStaffing variables automatically named OverStaffing(a,s,0) for j=0 (shown in FIG. 2B by reference numeral 105E2), and OverStaffing(a,s,1) for j=1 (shown in FIG. 2B by reference numeral 105E1) which are respectively 2.5 and 0.5. In this example, if the value OPenalty(0) for j=0 is 0.5 if the value OPenalty(1) for j=1 is 1.0 corresponding to variables OverStaffing(a,s,0) and OverStaffing(a,s,1) then the cost in the period between 12:45 pm and 1:15 pm may be calculated as 2.5*0.5+0.5*1=1.75. Thus, total cost for the schedule illustrated in FIG. 2B is 3.5+4+1.75=9.25.

As can be seen from the above illustrative description, the schedule of FIG. 2A has the cost of 11.25 whereas the schedule of FIG. 2B has the cost of 9.25, thereby to enable the schedule of FIG. 2B to be selected, for having lower cost. This is in contrast to a normal cost computation, in which for the schedule of FIG. 2A the cost is 3.5+4+2+1=10.5 and for the schedule of FIG. 2B cost is 3.5+4+3=10.5, both being identical. Hence, a normally calculated cost cannot distinguish between the schedules of FIGS. 2A and 2B due to the total costs being identical to one another, for the two schedules. In contrast, use of two OverStaffing variables at time 12:45 e.g. by multiplication thereof with two different values OPenalty enables greater resolution in assigning costs to gaps in coverage, in two (or more) schedules.

A processor 1105 (FIG. 5A) of some embodiments that performs a method shown in FIG. 3 or 4 is included in a computer that includes memory 1106, such as computer 1000 (FIGS. 5A and 5B) that automatically creates and/or automatically uses one or more new levels of workload. Specifically, processor 1105 is programmed in some embodiments, to execute software in memory 1106, to perform certain acts 301-308 illustrated in FIG. 3, to formulate constraints and prepare expressions in a cost function, based on one or more new workload levels BelowStD located below the curve StD and/or one or more new workload levels AboveStD located above the curve StD. In the following description, a single processor 1105 is sometimes described for convenience, although it is to be understood that multiple processors may be used, depending on the embodiment. Moreover, a single memory 1106 is sometimes described for convenience, although it is to be understood that multiple memories or other non-transitory computer readable media may be used, depending on the embodiment.

In act 301 illustrated in FIG. 3, a processor 1105 of some embodiments automatically selects a unit interval of time (also called time slot s) that is to be scheduled. Thereafter, in act 302 illustrated in FIG. 3, processor 1105 automatically selects an activity a of work to be done in time slot s, also called standard workload, StD(a,s), which is illustrated in FIG. 1A by curve 101. Next, in act 303, processor 1105 formulates a constraint, for use in scheduling employees to perform activity a in time slot s. The specific constraint formulated in act 303 can be different in different embodiments, although in many embodiments the constraint is formulated to include Expression (1) and/or Expression (2) noted above.

Specifically, in some embodiments of act 303, processor 1105 formulates a constraint to include therein at least one sum of a sequence of variables, such as Expression (1) noted above, e.g. the sum of variables UnderStaffing(a,s,i), with i ranging from 0 to n. In embodiments that do not account for overstaffing, the sum in Expression (1) may be used in a model to identify for time slot s, a gap between a workload of activity a and number of employees skilled at activity a. In act 303, processor 1105 may further create a constraint on each variable in the sequence, e.g. UnderStaffing(a,s,i) based on a corresponding difference between two successive workload levels, e.g. BelowStD(a,s,i) and BelowStD(a,s,i+1). For example, processor 1105 may automatically prepare a constraint in the model, as shown below:

UnderStaffing(a,s,i)≦BelowStD(a,s,i)≦BelowStD(a,s,i+1). Equation (1).

In some embodiments of act 303, processor 1105 may additionally or alternatively formulate another constraint to include therein another sum of a sequence of variables, such as Expression (2) noted above, e.g. the sum of variables OverStaffing(a,s,j), with j ranging from 0 to m. In such embodiments, Expression (3) discussed above may be used to indicate for time slot s, a gap between a workload of activity a and number of employees skilled at activity a. Processor 1105 may further create a constraint on each variable, e.g. OverStaffing(a,s,j) based on a corresponding difference between two successive workload levels, e.g. AboveStD(a,s,j) and AboveStD(a,s,j+1). For example, processor 1105 may automatically prepare another constraint in the model, as shown below:

OverStaffing(a,s,j)≦AboveStD(a,s,j+1)−AboveStD(a,s,j). Equation (2).

In act 304 illustrated in FIG. 3, processor 1105 of some embodiments automatically prepares, as an expression in a function to be used in optimization, when preparing schedules, a scalar product of the type described above in Expression (6). As noted above, Expression (6) includes a scalar product of (a) the sequence of variables and (b) a sequence of values (e.g. for penalty) indexed by an index i wherein a value at i which is multiplied with a variable associated with a new workload level at i depends on a distance between the standard workload StD and the new workload level at i. Accordingly, variables for new workload levels at successively larger distances from the standard workload are multiplied with successively larger values of penalty. In act 305, processor 1105 stores in memory 1106 (e.g. in a mathematical model), representations of one or more constraints formulated in act 303 and representations of one or more expressions prepared in act 304.

Next, in act 306, processor 1105 checks whether all activities a have been processed for preparation of constraints and expressions, and if not returns to act 302 (described above). When act 306 determines that all activities have been processed, then processor 1105 checks whether the schedule includes activities in all time slots s and if not then processor 1105 returns to act 301 (described above). When act 307 determines that all time slots have been processed (for preparation of constraints and expressions), then processor 1105 goes to act 308. In act 308, processor 1105 invokes a method based on a solver (e.g. a linear solver) to prepare schedules for employees, e.g. by satisfying one or more constraints formulated in act 303 while optimizing the schedules using a cost function based on the expressions prepared in act 304.

Acts 301-308 illustrated in FIG. 3 are performed in embodiments by processor 1105 executing software to implement a model generator 440 (FIG. 4). Model generator 440 includes computer instructions in memory 1106 that when executed by processor 1105 implement a constraint generator 441 and an objective function generator 442 to respectively perform acts 303 and 304 of FIG. 3 (described above). In performing acts 303 and 304, constraint generator 441 and objective function generator 442 may use certain data stored in memory 1106, such as a time data 411 that identifies, for example, time slots in a working day, workload data 412 that identifies, for example, activities to be performed and amount of time for which each identified activity needs to be performed, and employee data 413 that identifies, for example, the employees in an organization and their skills at performing the various activities.

In some embodiments, model generator 440 further includes a user interface 443 that may be used to receive user input on the number of new workload levels to be created, e.g. the user may identify the need for 2 workload levels above standard workload StD and 3 workload levels below standard workload StD. Accordingly, user interface 443 may store in memory 1106, the numbers 2 and 3 received as user input in data 414. User interface 443 may additionally or alternatively receive user input on maximum staffing level MaxStaffing and minimum staffing level MinStaffing either or both of which may also be stored as data 414 in memory 1106. Data 414 is used in model generator 440 of some embodiments, by a workload levels generator 445 (FIG. 4) included therein to generate data 415 on new workload levels of the type illustrated in FIG. 1A (as described above).

Data 415 is stored in memory 1106 and used by constraint generator 441 which includes computer instructions that when executed by processor 1105 perform act 303 (described above), to generate constraints 401A . . . 401L . . . 401Z (together referred to as constraints 401) that are then stored in a model 400 in memory 1106. Similarly, data 415 is used by objective function generator 442 which includes computer instructions that when executed by processor 1105 perform act 304 (described above), to generate expression s 402A . . . 402P . . . 402Y (together referred to as expressions 402) also stored in model 400 in memory 1106. Model generator 440 may include other logic, such as an equation and range generator 444 that generates equation 403A or range 403R also stored in model 400 in memory 1106. In some embodiments, each constraint 401L (FIG. 4) is used to store in memory 1106, an Equation (4) described below, which includes an Expression (3) described above, for a specific activity a during a specific time slot s. Moreover, in such embodiments, each expression 402P (FIG. 4) is used to store in memory 1106 an objective function to be minimized by a solver 420 (described below), wherein the objective function includes an Expression (6) described above.

In embodiments of the type illustrated in FIG. 4, model 400 defines a problem to be solved, while satisfying the constraints 401 and minimizing a function (including expressions 402) to be optimized to obtain schedules for the employees in the organization. Model 400 is solved automatically by use of a solver 420 that generates employee schedules 421 in the normal manner. Specifically, in several such embodiments, constraints 401 are linear and the function (which includes expressions 402) is also linear, and all other components of model 400 (such as equation 403A and range 403R) are linear as well. When model 400 is linear, and any solver that solves linear programming (LP) problems can be used as solver 420. One example of solver 420 is a linear solver known as ILOG CPLEX, available from IBM Corporation. In several embodiments, some variables in model 400 are submitted to obtain therefrom integer values for these variables, and any tool for solving mixed integer programs (MIP) may be used as solver 420.

One specific embodiment is described below, as an illustration although several such embodiments will be apparent in view of this detailed description. The illustrative embodiment described below optimizes coverage of workload during employee scheduling, by starting with the following input data. Input data 413 (described above in reference to FIG. 4) of this embodiment includes information on the employees in an organization, the skills of the employees, the availabilities of the employees, and any rules (called also constraints), e.g. based on governmental regulations and union contracts. Input data 412 (described above) of this embodiment includes information on activities with their respective demands, which compose the workload. Model generator 440 of this illustrative embodiment when operated with solver 420 provides a schedule 421 (FIG. 4) that matches as much as possible the contribution of employees with the workload, while satisfying the constraints.

A schedule 421 that is provided as a result of optimization by an (operational research based) engine in solver 420 in this illustrative embodiment is a detailed weekly schedule: detailed on activities with a 15 nm time step description. Schedule 421 shows, for each 15 minutes slot of the week, which activity every employee is scheduled to perform. Therefore, schedule 421 gives work times, break times and details of covered activities. Schedule 421 is prepared automatically (based on model 400) to respect contractual rules of employees (named also the HR constraints). Modeling of such constraints in order to be solved by an optimization engine can be done in any manner that will be apparent in view of this detailed description. Accordingly, model generator 440 prepares a model of workload coverage as follows.

For illustrative purposes, and without loss of generality, the following description may refer to an example of a retail market as an organization having several activities (business) to cover operationally every day. Some of these activities are: cashier, administration, sales, cleaning, shipping, management . . . etc. Every activity is defined on one or more time windows per day. A time window indicates, on the one hand, where the activity can be scheduled, and on the other hand, where there is a workload demand. In other terms, an activity cannot be assigned to an employee outside its times windows. Example: an activity administration having 2 time windows of workload: [10 am, 12 pm] in the morning and [2 pm, 4 pm] in the afternoon.

In the illustrative embodiment, business demand for an activity can be expressed in two main ways: Stationary: number of required people to perform this activity at every time point inside the time window(s). This number may change at every step of 15 minutes. Mobile: an amount of hours to be performed on this activity inside one or more time windows; more precisely, the value of the demand could be a duration needed to be distributed among all the time windows, or a value is given for each time window. Example: we need globally 2 hours of cleaning in the store between 8 am and 8 pm. Hence, depending on its demand, an activity can be: stationary, mobile, or mixed (when its demand is composed of two parts: stationary and mobile).

The illustrative embodiment also uses activity priority, which measures the relative importance of covering one activity relative to another. In other words, an activity with a greater priority is given more importance to be covered compared to another one with a lower priority. One of the innovative parts of the model 400 of the illustrative embodiment is that it handles several curves of stationary demand simultaneously for the same activity on the same time window. This allows the illustrative embodiment to represent accurately all the business requirements that a retail organization, for instance, may be facing.

In the illustrative embodiment, the data 412 includes information on standard workload StD. In addition, the illustrative embodiment further uses maximum staffing level MaxStaffing located above the standard workload StD to indicate that in some organizations, the manager does not want the number of assigned employees exceed the value specified at each time slot by this curve. In addition, the illustrative embodiment also uses minimum staffing level MinStaffing located below the standard workload StD to indicate that non satisfaction of the min staffing induces a big dysfunction in the organization.

In the illustrative embodiment, different penalties are associated to each of the above-described three workload levels, MinStaffing, StD and MaxStaffing since they don't have the same importance of satisfaction. In an operational schedule, understaffing relatively to standard demand is set to cost more than the overstaffing. This is the reason why in the illustrative embodiment, the understaffing penalty is set to twice the penalty of overstaffing. Moreover, in the illustrative embodiment, the understaffing relatively to the minimum staffing workload is highly penalized. Finally, in the in the illustrative embodiment, exceeding the maximum staffing curve costs as much as having less employees than the minimum staffing required.

To obtain a smooth distribution of workload coverage in the optimization result, the illustrative embodiment, generates new intermediate workload levels (demands). In the illustrative embodiment, these new intermediate workload levels are not made visible to the user. Instead, the new intermediate workload levels are added artificially between the ‘real’ demand curves of MinStaffing, StD and MaxStaffing. In the illustrative embodiment, the number of new intermediate workload levels is configurable based on user input, which may be received when the software is initially installed on a user's computer.

In the illustrative embodiment, one or more new intermediate workload levels (artificial demands) are computed internally by equal distribution between a pair of ‘real’ demand curves, e.g. (MinStaffing, StD) or (StD, MaxStaffing). For example, to add a single new intermediate workload level, the illustrative embodiment, simply places it in the middle between the pair of ‘real’ demand curves. More generally, a new intermediate workload level Demand (j) of index j is added in the illustrative embodiment between two primary curves Demand(0) and Demand(n) as follows, for j=1 . . . n−1:

$$Demand ( j ) = ( 1 - \frac{j}{n} ) \times Demand ( 0 ) + ( \frac{j}{n} ) \times Demand ( n ) . \qquad Equation ( 3 ) .$$

The illustrative embodiment adds a constraint to model 400 as follows:

coverage(a,s)+Σᵢ₌₀ⁿUnderStaffing(a,s,i)−Σⱼ₌₀^{m}OverStaffing(a,s,j)+UnderMobile(a,s)=StD(a,s)+MobileDemandOnSlot(a,s) Equation (4).

where:

coverage(a,s) is an expression of the coverage of activity a on slot s summing the contributions of all employees who are skilled at the concerned activity a,

UnderMobile(a,s) is the under slack variable of activity a on slot s counting the understaffing according to a mobile workload specified by user input,

UnderStaffing(a,s,0) is the under slack variable measured relative to standard workload StD,

UnderStaffing(a,s,i) for i≧1 is an under slack variable measured relative to new workload level BelowStD(a,s,i),

OverStaffing(a,s,0) is an over slack variable measured relative to standard workload StD,

OverStaffing(a,s,j) for j≧1 is the over slack variable measured relative to new workload level AboveStD(a,s,j),

StD(a,s) is the standard workload of activity a in slot s,

MobileDemandOnSlot(a,s) is a variable which represents, in terms of number of employees, the mobile workload distributed on the time slot s. That means that the sum of these variables multiplied by the slot duration is equal to the true mobile demand value.

Thus, the constraint added to model 400 (above) includes additional variable MobileDemandOnSlot(a,s) to represent a mobile workload specified for activity a to be scheduled in any time slot among multiple time slots in a group that includes time slot s. When we deal with a different mobile value per time window (denoted TW) we have:

ΣSεTWMobileDemandOnSlot(a,s)=MobileDemand(a)/SlotDuration Equation (5)

where SlotDuration of some embodiments is 15 minutes (but can be configured to another duration). In case of a single mobile demand value for several time windows (i.e., for the day entirely), the mobile demand distribution is defined by:

Σ_{SεDay}MobileDemandOnSlot(a,s)=MobileDemand(a)/SlotDuration Equation (6)

The expression coverage(a,s) is defined by

$$coverage ( a , s ) = {\sum }_{e} Schedule ( e , a , s )$$

where Schedule(e,a,s) is a binary variable representing any schedule of an employee e who performs activity a in slot s.

As noted above, the illustrative embodiment is designed to increase cost as the coverage gets farther from the standard workload StD. To implement this, the illustrative embodiment binds the slack variables (UnderStaffing and OverStaffing) with respect to the workload levels as follows.

UnderStaffing(a,s,0)≦StD(a,s)−BelowStD(a,s,1).

For all i, 1≦i≦n−1,

UnderStaffing(a,s,i)≦BelowStD(a,s,i)−BelowStD(a,s,i+1).

UnderStaffing(a,s,n)≦BelowStD(a,s,n).

Hence, in certain embodiments that use range expressions of the type listed above for the activity a in the time slot s, each variable in a sequence of UnderStaffing variables except a last variable therein is less than or equal to a difference between two successive values in the sequence of values BelowStD, and the last variable in the sequence of UnderStaffing variables is less than or equal to a last value in the sequence of BelowStD values. In embodiments that support mobile workloads, an additional range expression may be used, as follows:

UnderMobile(a,s)≦MobileDemandOnSlot(a,s)

For the over slack variables OverStaffing(a,s,j) the bounds are calculated a slightly differently from the under slack variables. Specifically, the illustrative embodiment permits a user to specify mixed activities which include mobile demand (not required to be performed in one specific time slot) in addition to standard workload StD. Overstaffing exists only when coverage exceeds the sum of standard workload StD and mobile demand, as follows:

OverStaffing(a,s,0)≦AboveStD(a,s,1)−StD(a,s)−MobileDemandOnSlot(a,s)

The other over slack variables which correspond to artificial workload levels above the standard workload StD are bounded as follows.
For all j, 1≦j<m−1,

OverStaffing(a,s,j)≦AboveStD(a,s,j+1)−AboveStD(a,s,j)

The variable OverStaffing(a,s,m) and variable MobileDemandOnSlot(a,s) have no upper bound. Hence, in certain embodiments that use range expressions of the type listed above for the activity a in the time slot s, each variable in a sequence of OverStaffing variables except a first variable therein is less than or equal to a difference between two successive values in the sequence of values AboveStD, and the first variable in the sequence of OverStaffing variables is less than or equal to a difference between: a first value in the sequence of AboveStD values and at least the number of employees needed to perform the activity a in the time slot s or StD(a,s) and when specified any additional number of employees needed to perform the activity a in the time slot s or MobileDemandOnSlot(a,s).

Note that in the illustrative embodiment, there is no specific over slack variable defined for the mobile demand. The reason is that in the illustrative embodiment the over staffing is computed globally as a remaining value that comes after covering the standard workload StD and the mobile workload.

In the illustrative embodiment, the slack variables are required to respect a saturation condition. Specifically, a slack variable UnderStaffing(a,s,i) is non-zero only if the understaffing slack variables measured relative to the workload levels above BelowStD(a,s,j), j<i are saturated (i.e. equal to their upper bounds). Accordingly, the following link is established between the understaffing slack variables, for all i, 1≦<n−1,

UnderStaffing(a,s,i+1)>0=>UnderStaffing(a,s,i)=BelowStD(a,s,i)−BelowStD(a,s,i+1).

Similarly the overstaffing slack variables are subjected to a similar saturation condition, for all j, 1≦j<m−1,

OverStaffing(a,s,j+1)>0=>OverStaffing(a,s,j)=AboveStD(a,s,j)−AboveStD(a,s,j+1).

The above two constraints on UnderStaffing(a,s,i) and OverStaffing(a,s,j) are not explicitly added to model 400 because model 400 includes as a cost function the scalar product in Expression (6), described above.

In the illustrative embodiment, the user is enabled to express other demands, e.g. a number of employees of a specified skill required to be present (doing some activities) inside specified time windows. Such workload levels are called core demands, and are modeled in the normal manner by defining new activities called core activities. Examples of core demand are: Presence of a key holder during store opening/closing hours and/or Presence of 2 Spanish speakers during operational hours. Therefore the illustrative embodiment enables a kind of special presence concerning a particular skill or a combination of skills The formal definition of core demand is a number of required employees among a subset of qualified employees during some time interval, who are assigned to some compatible activities. By definition, the core demand can be only stationary (i.e. specified to be in a particular time slot s). This compatibility relationship means that every time an employee is assigned to some of these pure business activities, he is considered at the same time as present for the core activity, so covering the core demand. The workload constraint for a core activity c, on each time slot s is written as follows:

$${\sum }_{a compatible with c} coverage ( a , s ) + UnderCore ( c , s ) - OverCore ( c , s )$$

As noted above for standard workload StD, in a similar manner for the equation above, both under core slack variable UnderCore(c,s) and over core slack variable OverCore(c,s) are non negative, and included in the cost function (after being multiplied by associated penalties). Thus, the above equation introduces a first additional variable CoreDemand(c,s) to represent a number of employees whose presence is specified to be scheduled in time slot s to cover a core activity c. Moreover, the above equation introduces two additional variables UnderCore(c,s) and OverCore(c,s) to represent a gap (negative or positive) between: the number of employees whose presence is specified to be scheduled in time slot s to cover the core activity c; and a number of employees to be scheduled to perform activity a in time slot s whose presence covers the core activity c.

The method of FIG. 3 may be used to program one or more computer(s) 1000, each of which may be implemented as illustrated in FIG. 5A which is discussed next. Specifically, computer 1000 includes a bus 1102 (FIG. 5A) or other communication mechanism for communicating information, and one or more processor(s) 1105 coupled with bus 1102 for processing information. Computer 1000 uses (as the above-described memory) a main memory 1106, such as a random access memory (RAM) or other dynamic storage device, coupled to bus 1102 for storing information and instructions (e.g. to perform the acts of FIG. 3) to be executed by processor 1105.

Main memory 1106 also may be used for storing temporary variables or other intermediate information during execution of instructions to be executed by processor 1105. Computer 1000 further includes a read only memory (ROM) 1104 or other static storage device coupled to bus 1102 for storing static information and instructions for processor 1105, such as software in the form of model generator 440. A storage device 1110, such as a magnetic disk or optical disk, is provided and coupled to bus 1102 for storing information and instructions.

Computer 1000 may be coupled via bus 1102 to a display device or video monitor 1112 such as a cathode ray tube (CRT) or a liquid crystal display (LCD), for displaying information to a computer user (e.g. a store manager) may be displayed on display 1112. An input device 1114, including alphanumeric and other keys (e.g. of a keyboard), is coupled to bus 1102 for communicating information (such as user input) to processor 1105 (e.g. executing user interface 443 of FIG. 4). Another type of user input device is cursor control 1116, such as a mouse, a trackball, or cursor direction keys for communicating information and command selections to processor 1105 and for controlling cursor movement on display 1112. This input device typically has two degrees of freedom in two axes, a first axis (e.g., x) and a second axis (e.g., y), that allows the device to specify positions in a plane. In addition to display device 1112, computer 1000 may include a speaker (not shown) as another output device for use by processor 1105 (e.g. executing user interface 443 of FIG. 4).

As described elsewhere herein, workforce management is implemented by computer 300 in response to processor 1105 executing one or more sequences of one or more instructions that are contained in main memory 1106. Such instructions may be read into main memory 1106 from another non-transitory computer-readable storage medium, such as storage device 1110. Execution of the sequences of instructions contained in main memory 1106 causes processor 1105 to perform the operations of a process described herein and illustrated in FIG. 3. In alternative embodiments, hard-wired circuitry may be used in place of or in combination with software instructions to implement the invention. Thus, embodiments of the invention are not limited to any specific combination of hardware circuitry and software.

The term “non-transitory computer-readable storage medium” as used herein refers to any non-transitory storage medium that participates in providing instructions to processor 1105 for execution. Such a non-transitory storage medium may take many forms, including but not limited to (1) non-volatile storage media, and (2) volatile storage media. Common forms of non-volatile storage media include, for example, a floppy disk, a flexible disk, hard disk, optical disk, magnetic disk, magnetic tape, or any other magnetic medium, a CD-ROM, any other optical medium, punch cards, paper tape, any other physical medium with patterns of holes, a PROM, and EPROM, a FLASH-EPROM, any other memory chip or cartridge that can be used as storage device 1110, to store program code in the form of instructions and/or data structures and that can be accessed by computer 1000. Volatile storage media includes dynamic memory, such as main memory 1106 which may be implemented in the form of a random access memory or RAM.

Instructions to processor 1105 can be provided by a transmission link or by a non-transitory storage medium from which a computer can read information, such as data and/or code. Specifically, various forms of transmission link and/or non-transitory storage medium may be involved in providing one or more sequences of one or more instructions to processor 1105 for execution. For example, the instructions may initially be comprised in a non-transitory storage device, such as a magnetic disk, of a remote computer. The remote computer can load the instructions into its dynamic memory (RAM) and send the instructions over a telephone line using a modem.

A modem local to computer 1000 can receive information about a change to a collaboration object on the telephone line and use an infra-red transmitter to transmit the information in an infra-red signal. An infra-red detector can receive the information carried in the infra-red signal and appropriate circuitry can place the information on bus 1102. Bus 1102 carries the information to main memory 1106, from which processor 1105 retrieves and executes the instructions. The instructions received by main memory 1106 may optionally be stored on storage device 1110 either before or after execution by processor 1105.

Computer 1000 also includes a communication interface 1115 coupled to bus 1102. Communication interface 1115 provides a two-way data communication coupling to a network link 1120 that is connected to a local network 1122. Local network 1122 may interconnect multiple computers (as described above). For example, communication interface 1115 may be an integrated services digital network (ISDN) card or a modem to provide a data communication connection to a corresponding type of telephone line. As another example, communication interface 1115 may be a local area network (LAN) card to provide a data communication connection to a compatible LAN. Wireless links may also be implemented. In any such implementation, communication interface 1115 sends and receives electrical, electromagnetic or optical signals that carry digital data streams representing various types of information.

Network link 1120 typically provides data communication through one or more networks to other data devices. For example, network link 1120 may provide a connection through local network 1122 to a host computer 1125 or to data equipment operated by an Internet Service Provider (ISP) 1126. ISP 1126 in turn provides data communication services through the world wide packet data communication network 1124 now commonly referred to as the “Internet”. Local network 1122 and network 1124 both use electrical, electromagnetic or optical signals that carry digital data streams. The signals through the various networks and the signals on network link 1120 and through communication interface 1115, which carry the digital data to and from computer 1000, are exemplary forms of carrier waves transporting the information.

Computer 1000 can send messages and receive data, including program code, through the network(s), network link 1120 and communication interface 1115. In the Internet example, a server 1100 might transmit information retrieved from RDBMS database through Internet 1124, ISP 1126, local network 1122 and communication interface 1115. The instructions for performing the operations of FIG. 3 may be executed by processor 1105 as they are received, and/or stored in storage device 1110, or other non-volatile storage for later execution. In this manner, computer 300 may additionally or alternatively obtain instructions and any related data in the form of a carrier wave.

Note that FIG. 5A is a very low-level representation of many hardware components of a computer system. Several embodiments have one or more additional software components in main memory 1106 as shown in FIG. 5B. In addition to main memory 1106, computer 1000 may include one or more other types of memory such as flash memory (or SD card) and/or a hard disk and/or an optical disk (also called “secondary memory”) to store data and/or software for loading into memory 1106 (also called “main memory”) and/or for use by processor(s) 1105. In some embodiments, computer 1000 of FIG. 5A implements a relational database management system 1905 to manage data in one or more tables of a relational database 1903 of the type illustrated in FIG. 5B. Such a relational database management system 1903 may manage a distributed database system that includes multiple databases, each table being stored on different storage mechanisms.

In some embodiments, the multiple databases are made to appear as a single database. In such embodiments, processor 1105 can access and modify the data in a relational database 138 via RDBMS 1903 that accepts queries in conformance with a relational database language, the most common of which is the Structured Query Language (SQL). The commands are used by processor 1105 of some embodiments to store, modify and retrieve data about an application program in the form of rows in a table in relational database 138. Relational database management system 1903 further includes output logic that makes the data in a database table available to a user via a graphical user interface that generates a screen on a video monitor display 1112. In one example, the output logic of computer 1000 provides results via a web-based user interface that depicts in a browser, information related to new workload levels as illustrated in FIG. 1A which can be used to prepare model 400 (FIG. 4). Additionally and/or alternatively, screens responsive to a command in a command-line interface and display on a video monitor may be generated in a user interface 443 (such as a GUI of the type described above in reference to FIG. 4).

In some embodiments of computer 1000, functionality in the above-described model generator 110 is implemented by processor 1105 executing software in memory 1106 of computer 1000, although in other embodiments such functionality is implemented in any combination of hardware circuitry and/or firmware and/or software in computer 1000. Depending on the embodiment, various functions of the type described herein may be implemented in software (executed by one or more processors or processor cores) or in dedicated hardware circuitry or in firmware, or in any combination thereof. Accordingly, depending on the embodiment, any one or more of model generator 440 and solver 420 can, but need not necessarily include, one or more microprocessors, embedded processors, controllers, application specific integrated circuits (ASICs), digital signal processors (DSPs), multi-core processors and the like.

Any non-transitory computer readable medium tangibly embodying software (also called “computer instructions”) may be used in implementing one or more acts described herein and illustrated in FIG. 3. Such software may include program codes stored in memory 1106 and executed by processor 1105. Memory 1106 may be implemented within or external to processor 1105, depending on the embodiment. When implemented in firmware and/or software, logic to perform one or more acts of FIG. 3 may be stored as one or more computer instructions or code on a non-transitory computer-readable medium. Examples include non-transitory computer-readable storage media encoded with a data structure that holds model 400 (FIG. 4) and non-transitory computer-readable storage media encoded with a computer program to implement model generator 440.

In some embodiments, a computer 1000 may include multiple processors, each of which is programmed with software in a memory 1106 shared with each other to perform acts of the type described above to model a gap between workload and number of employees to be scheduled, by creating and using new workload levels. For example, a first processor 1105 in computer 1000 may be programmed with software to implement means for formulating, for inclusion in a constraint to be used in scheduling employees to perform an activity (e.g. in time slots of a day in a week), a sum of a first sequence of variables, which is then input to a solver. In the just described example, a second processor 1105 in computer 1000 may be programmed with software to implement means for preparing, for inclusion in a function to be optimized during the scheduling, a scalar product of the first sequence of variables and a second sequence of values, also input to the solver. The solver may be implemented by either the first processor or the second processor or both processors.

Although two processors 1105 have been just described for some embodiments to implement the respective means for formulating and means for preparing, in other embodiments a single processor 1105 may be used in a time shared manner to implement the just-described two means. Furthermore, in still other embodiments, one processor 1105 may be used in a time-shared manner to implement one or more parts of the means for formulating and one or more parts of the means for preparing, and one or more other processors 1105 may be also used in a time-shared manner to implement other parts of the means for formulating and other parts of the means for preparing. Furthermore, although processors 1105 have been described above for certain embodiments as being included in a single computer 1000, in other embodiments two processors 1105 may be included in two computers 1000 so that a first computer 1000 implements the means for formulating and a second computer 1000 implements the means for preparing.

In one or more such embodiments, one or more processor(s) 1105 with a bus 1103 implement means for storing in memory 1106, the outputs generated by the means for formulating and the means for preparing, in the form of one or more formulaic representations (e.g. expressed as strings of text) for use in model 400 in memory 1106, e.g. representations of sums in constraints 401 and representations of scalar products in expressions 402, for use by a solver 420. One or more such processors 1105 may also implement other functionality in model generator 440, such as an equation and range generator 444 that generates representations of one or more equations 403A and representations of one or more ranges 403R in model 400 (see FIG. 4). One or more such processors 1105 may further implement additional functionality in model generator 440, such as a user interface 443 that generates screens on display 1112 through which a user may view (and use a keyboard and/or mouse to edit) data in memory 1106, such as time slots on a working day 411, workload 412 (including activities and time slots), employees and skills 413, representations of sums in constraints 401, and representations of scalar products in expressions 402, and employee schedules 421 output by solver 420. Such schedules 421 may be stored in database 138, and specify for each employee, information on each time slot in a day (e.g. identified by start time & duration), e.g. a specific activity which is to be performed by a specific employee in a specific time slot.

Numerous modifications and adaptations of the embodiments described herein will become apparent to the skilled artisan in view of this disclosure. Numerous modifications and adaptations of the embodiments described herein are encompassed by the scope of the invention.

1. A computer-implemented method to smoothen workload coverage in employee scheduling, the method comprising:
at least one processor formulating, for inclusion in a constraint to be used in scheduling employees to perform an activity a among a plurality of predetermined activities to be performed in an organization within a time slot s among a plurality of predetermined time slots in a day, a representation of a sum of a first sequence of variables;
wherein the sum of the first sequence of variables represents a gap between:
a number of employees needed to perform the activity a in the time slot s; and
the number of employees to be scheduled in the time slot s and skilled at performing the activity a;
the at least one processor preparing, for inclusion in a function to be optimized during scheduling, a representation of a scalar product of the first sequence of variables and a second sequence of values;
wherein each value in the second sequence, which is multiplied with a corresponding variable in the first sequence, depends on a corresponding distance between:
the number of employees needed to perform the activity a in the time slot s; and
a workload level indicated by the corresponding variable with which said each value is multiplied; and
the at least one processor storing in the memory, the representation of the sum and the representation of the scalar product.

2. The method of claim 1 wherein:
the representation of the sum and the representation of the scalar product are stored in a model; and
the model defines a problem to be solved, while satisfying the constraint and minimizing the function to be optimized, to obtain schedules for the employees in the organization.

3. The method of claim 2 wherein:
the constraint is linear;
the function is linear; and
the model is linear.

4. The method of claim 1 wherein:
each variable in the first sequence of variables denotes a portion of understaffing represented by the gap, when the number of employees needed to perform the activity a in the time slot s is greater than the number of employees to be scheduled in the time slot s and skilled at performing the activity a.

5. The method of claim 4 wherein, for the activity a in the time slot s:
each variable in the first sequence except a last variable therein is less than or equal to a difference between two successive values in a third sequence of values; and
the last variable in the first sequence is less than or equal to a last value in the third sequence of values.

6. The method of claim 4 wherein the sum of the first sequence of variables is hereinafter understaffing sum, and wherein the method further comprises:
the at least one processor additionally formulating, for inclusion in the constraint, an additional representation of another sum of a third sequence of variables, hereinafter overstaffing sum;
wherein each variable in the third sequence of variables denotes a portion of overstaffing represented by the gap, when the number of employees needed to perform the activity a in the time slot s is less than the number of employees to be scheduled in the time slot s and skilled at performing the activity a.

7. The method of claim 6 wherein:
the constraint comprises a representation of subtraction between the understaffing sum and the overstaffing sum.

8. The method of claim 6 wherein, for the activity a in the time slot s:
each variable in the third sequence except a first variable therein is less than or equal to a difference between two successive values in a fourth sequence of values; and
the first variable in the third sequence is less than or equal to a difference between:
a first value in the fourth sequence of values; and
at least the number of employees needed to perform the activity a in the time slot s, and when specified any additional number of employees needed to perform the activity a in the time slot s.

9. The method of claim 1 wherein:
a second value in the second sequence occurs after a first value therein; and
the second value is greater than the first value.

10. The method of claim 1 wherein the scalar product is hereinafter first scalar product, and the method further comprises:
the at least one processor additionally preparing a representation of a second scalar product of a third sequence of variables and a fourth sequence of values;
wherein the function comprises a representation of subtraction between the first scalar product and the second scalar product.

11. At least one non-transitory computer readable storage media comprising a plurality of instructions to be executed by at least one processor, the plurality of instructions comprising:
instructions to at least one processor to formulate, for inclusion in a constraint to be used in scheduling employees to perform an activity a among a plurality of predetermined activities to be performed in an organization within a time slot s among a plurality of predetermined time slots in a day, a representation of a sum of a first sequence of variables;
wherein the sum of the first sequence of variables represents a gap between:
a number of employees needed to perform the activity a in the time slot s; and
the number of employees to be scheduled in the time slot s and skilled at performing the activity a;
instructions to the at least one processor to prepare, for inclusion in a function to be optimized during scheduling, a representation of a scalar product of the first sequence of variables and a second sequence of values;
wherein each value in the second sequence, which is multiplied with a corresponding variable in the first sequence, depends on a corresponding distance between:
the number of employees needed to perform the activity a in the time slot s; and
a workload level indicated by the corresponding variable with which said each value is multiplied; and
instructions to the at least one processor to store in the memory, the representation of sum and the representation of the scalar product.

12. The at least one non-transitory computer readable storage media of claim 11 wherein:
the sum and the scalar product are to be stored in a model and
the model defines a problem to be solved, while satisfying the constraint and minimizing the function to be optimized, to obtain schedules for the employees in the organization.

13. The at least one non-transitory computer readable storage media of claim 12 wherein:
the constraint is linear;
the function is linear; and
the model is linear.

14. The at least one non-transitory computer readable storage media of claim 11 wherein:
the sum and the scalar product are stored in an equation in a model that defines a problem to be solved, while satisfying the constraint and minimizing the function to be optimized, to obtain schedules for the employees in the organization.

15. The at least one non-transitory computer readable storage media of claim 11 wherein:
each variable in the first sequence of variables denotes a portion of understaffing represented by the gap, when the number of employees needed to perform the activity a in the time slot s is greater than the number of employees to be scheduled in the time slot s and skilled at performing the activity a.

16. The at least one non-transitory computer readable storage media of claim 11 wherein, for the activity a in the time slot s:
each variable in the first sequence except a last variable therein is less than or equal to a difference between two successive values in a third sequence of values; and
the last variable in the first sequence is less than or equal to a last value in the third sequence of values.

17. The at least one non-transitory computer readable storage media of claim 11 wherein the sum of the first sequence of variables is hereinafter understaffing sum, and wherein the plurality of instructions further comprises:
instructions to the at least one processor to additionally formulate, for inclusion in the constraint, an additional representation of another sum of a third sequence of variables, hereinafter overstaffing sum;
wherein each variable in the third sequence of variables denotes a portion of overstaffing represented by the gap, when the number of employees needed to perform the activity a in the time slot s is less than the number of employees to be scheduled in the time slot s and skilled at performing the activity a.

18. The at least one non-transitory computer readable storage media of claim 11 wherein the scalar product is hereinafter first scalar product, and the plurality of instructions further comprise:
instructions to the at least one processor to additionally prepare a representation of a second scalar product of a third sequence of variables and a fourth sequence of values;
wherein the function comprises a representation of subtraction between the first scalar product and the second scalar product.

19. An apparatus to smoothen workload coverage in employee scheduling, the apparatus comprising:
means for formulating, for inclusion in a constraint to be used in scheduling employees to perform an activity a among a plurality of predetermined activities to be performed in an organization within a time slot s among a plurality of predetermined time slots in a day, a representation of a sum of a first sequence of variables;
wherein the sum of the first sequence of variables represents a gap between:
a number of employees needed to perform the activity a in the time slot s; and
the number of employees to be scheduled in the time slot s and skilled at performing the activity a;
means for preparing, for inclusion in a function to be optimized during scheduling, a representation of a scalar product of the first sequence of variables and a second sequence of values;
wherein each value in the second sequence, which is multiplied with a corresponding variable in the first sequence, depends on a corresponding distance between:
the number of employees needed to perform the activity a in the time slot s; and
a workload level indicated by the corresponding variable with which said each value is multiplied; and
means for storing in memory, the representation of the sum and the representation of the scalar product.

20. The apparatus of claim 19 wherein:
the constraint and the objective function are stored in a model; and
the model defines a problem to be solved, while satisfying the constraint and minimizing the function to be optimized, to obtain schedules for the employees in the organization.

21. The apparatus of claim 20 wherein:
the constraint is linear;
the function is linear; and
the model is linear.
